(19) United States
(12) Patent Application Publication
(10) Pub. No.: US 2004/0167009 A1
(43) Pub. Date: Aug. 26, 2004

(54) Ceramic materials reinforced with metal and single-wall carbon nanotubes

(75) Inventors: Joshua D. Kuntz, Lafayette, CA (US); Guodong Zhan, Davis, CA (US); Amiya K. Mukherjee, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THE REGENTS OF THE UNIVERSITY OF CALIFORNIA, a California corporation, Oakland, CA

(21) Appl. No.: 10/377,172

(22) Filed: Feb. 26, 2003

(51) Int. Cl. H05B 6/00; C04B 35/80; C04B 35/117

(52) U.S. Cl. 501/95.2; 264/430; 264/434; 501/127

(57) ABSTRACT

High-density composites of ceramic materials, notably alumina or metal oxides in general, are formed by the incorporation of metal particles, of which niobium is a preferred example, and single-wall carbon nanotubes. The composites demonstrate an unusually high fracture toughness compared to the ceramic alone, and also when compared to composites that contain either the metal alone or single-wall carbon nanotubes alone. The two additives thus demonstrate a synergistic effect in improving the toughness of the ceramic.

### STATEMENT AS TO RIGHTS TO INVENTIONS MADE UNDER FEDERALLY SPONSORED RESEARCH OR DEVELOPMENT

This invention was made with Government support under Contract No. G-DAAD 19-00-1-0185, awarded by the United States Army Research Office. The Government has certain rights in this invention.

### BACKGROUND OF THE INVENTION

1. Field of the Invention

This invention resides in the field of ceramics, and incorporates technologies relating to nanocrystalline materials, carbon nanotubes, and sintering methods for densification and property enhancement of materials.

2. Description of the Prior Art

Ceramics that have microstructures consisting of nano-sized crystalline grains or that are formed by the consolidation and densification of nano-sized powders, are known to be superior in various ways to ceramics with larger-grain microstructures. As a result, nanocrystalline ceramics hold promise as high-performance materials for a wide variety of applications extending from microelectromechanical devices (MEMS) to materials of construction for heat engines, cutting tools, wear and friction surfaces, and space vehicles. Fulfillment of the promise of nanocrystalline ceramics has been limited however by the brittleness of these materials.

To reduce the brittleness of nanocrystalline ceramics, composites have been developed in which secondary materials are dispersed throughout the ceramic matrix material. In some of the more recent developments, carbon nanotubes, specifically multi-wall carbon nanotubes, have been used as the secondary material. A description of “ceramic matrix nanocomposites containing carbon nanotubes” is found in Chang, S., et al. (Rensselaer Polytechnic Institute), U.S. Pat. No. 6,420,293 B 1, issued Jul. 16, 2002 on an application filed on Aug. 25, 2000. While the description encompasses both single-wall and multi-wall carbon nanotubes, the only carbon nanotubes for which test data is presented in the patent are multi-wall carbon nanotubes. The only method that the patent describes for the sintering of the starting powders to form a dense continuous mass is hot isostatic pressing.

Single-wall carbon nanotubes possess extraordinary electrical conductivity as well as a thermal conductivity that is twice that of diamond. Thus, polymers to which single-wall carbon nanotubes have been added possess an electrical conductivity that is high enough to provide an electrostatic discharge. Other extraordinary properties of single-wall carbon nanotubes are mechanical properties such as stiffness (a Young's modulus of 1,400 GPa) and strength (a tensile strength well above 100 GPa). While the electrical properties have been successfully exploited, however, the mechanical properties have not. Iron-alumina composites that include carbon nanotubes, for example, have demonstrated a fracture strength that is only marginally higher than that of alumina alone and markedly lower than carbon-free iron-alumina composites. Nor has there been much improvement in fracture toughness. The best results reported to date are those of Siegel, R. W., et al., in Scripta mater. 44 (2001): 2061-2064, in which a 24% increase in fracture toughness of alumina was achieved by nanosized alumina filled with multi-wall carbon nanotubes.

In separate developments, refractory metals such as niobium, molybdenum and iron have been investigated as the secondary material. A study of alumina-niobium composites is reported by Scheu, C., et al., “Microstructure of Alumina Composites Containing Niobium and Niobium Aluminudes,” J. Am. Ceram. Soc. 83(2): 397-402 (2000). The composites in the study were prepared by pressureless sintering, and had densities of 95% to 98% of the theoretical density.

Of further relevance to this invention is the literature on electric field-assisted sintering, which is also known as spark plasma sintering, plasma activated sintering, and field-assisted sintering technique. Electric field-assisted sintering is disclosed in the literature for use on metals and ceramics, for consolidating polymers, for joining metals, for crystal growth, and for promoting chemical reactions. The densification of alumina powder by electric field-assisted sintering is disclosed by Wang, S. W., et al., J Mater. Res. 15(4) (April 2000): 982-987.

### SUMMARY OF THE INVENTION

It has now been discovered that a ceramic material that consists of a fused mass containing ceramic grains with both metal grains and single-wall carbon nanotubes dispersed throughout the ceramic grains, that has been densified to a relative density of at least 99%, has unusually high fracture toughness and favorable mechanical properties in general. This microstructure can be achieved by combining single-wall carbon nanotubes and powdered niobium with ceramic particles, preferably nano-sized, and consolidating the resulting mixture into a continuous mass by electric field-assisted sintering. In the case of alumina as a representative ceramic material, the resulting composite possesses a toughness that far exceeds the toughness of pure nanocrystalline alumina that has been sintered under the same conditions, as well as the toughnesses of composites of alumina and niobium without single-wall carbon nanotubes and composites of alumina and single-wall carbon nanotubes without niobium, all sintered under the same conditions. In addition to the improved mechanical properties of these niobium- and carbon nanotube-containing composites, the invention offers an improvement through its use of electric field-assisted sintering which offers a reduction in processing time relative to other sintering methods.

These and other features, advantages and objects of this invention will be apparent from the description that follows. All literature references cited in this specification are incorporated herein by reference for their descriptions of the subject matter in the contexts of which the citations are made.

### BRIEF DESCRIPTION OF THE FIGURE

FIG. 1 is a plot of fracture toughness of sintered alumina and alumina-based composites vs. amount of carbon nanotubes present in these materials, listing test results generated by the inventors herein together with test results reported in the literature.

### DETAILED DESCRIPTION OF THE INVENTION AND PREFERRED EMBODIMENTS

The ceramic materials that form the major component of the composites of this invention include any known ceramics, although preferred ceramics for use in this invention are metal oxides. Examples of metal oxide ceramics are alumina, magnesium oxide, titania, cerium oxide, yttria, and zirconia. Further examples are combinations of two or more of these metal oxides, and combinations that include other oxides such as silica and other metal and non-metal oxides. Still further examples are mixed metallic oxides such as SiAlON, AlON, spinels, notably magnesia spinel, and calcium aluminate. A metal oxide that is currently of particular interest is alumina, either α-alumina, γ-alumina, or a mixture of both.

The metal grains are either aluminum, chromium, copper, molybdenum, niobium, nickel, titanium, or tungsten, combinations of these metals, or alloys in which these metals serve as the major component. A preferred metal is niobium, which is widely used in the steel industry as an additive for high-strength steels, low-alloy steels, and carbon steels. Niobium is also used in the manufacture of high-performance materials for the aerospace industry and in various types of electrical equipment. All of these metals are readily available from commercial suppliers in powder form, and niobium powder in particular is commercially available from suppliers to the electronics and aerospace industries. For use in the present invention, niobium is preferably supplied as a powder in the micron or sub-micron range.

Carbon nanotubes are polymers of pure carbon. Both single-wall and multi-wall carbon nanotubes are known in the art and the subject of a considerable body of published literature. Examples of literature on the subject are Dresselhaus, M. S., et al., Science of Fullerenes and Carbon Nanotubes, Academic Press, San Diego (1996), and Ajayan, P. M., et al., “Nanometre-Size Tubes of Carbon,” Rep. Prog. Phys. 60 (1997): 1025-1062. The structure of a single-wall carbon nanotube can be described as a single graphene sheet rolled into a seamless cylinder whose ends are either open or closed. When closed, the ends are capped either by half fullerenes or by more complex structures such as pentagonal lattices. The average diameter of a single-wall carbon nanotube is within the range of 0.5 to 100 nm, and more typically, 0.5 to 10 nm, 0.5 to 5 nm, or 0.7 to 2 nm. The aspect ratio, i.e., length to diameter, can range from about 25 to about 1,000,000, and preferably from about 100 to about 1,000. Thus, a nanotube of 1 nm diameter may have a preferred length of from about 100 to about 1,000 nm. (All ranges stated herein are approximate.) Nanotubes frequently exist as “ropes,” which are bundles of 10 to 100 nanotubes held together along their lengths by van der Waals forces, with individual nanotubes branching off and joining nanotubes of other “ropes.” Multi-walled carbon nanotubes are multiple concentric cylinders of graphene sheets. The cylinders are of successively larger diameter to fit one inside another, forming a layered composite tube bonded together by van der Waals forces, the distance between layers typically being approximately 0.34 nm as reported by Peigney, A., et al., “Carbon nanotubes in novel ceramic matrix nanocomposites,” Ceram. Inter. 26 (2000) 677-683.

Carbon nanotubes are commonly prepared by arc discharge between carbon electrodes in an inert gas atmosphere. The product is generally a mixture of single-wall and multi-wall nanotubes, although the formation of single-wall nanotubes can be favored by the use of transition metal catalysts such as iron or cobalt. Single-wall nanotubes can also be prepared by laser ablation, as disclosed by Thess, A., et al., “Crystalline Ropes of Metallic Carbon Nanotubes,” Science 273 (1996): 483-487, and by Witanachi, S., et al., “Role of Temporal Delay in Dual-Laser Ablated Plumes,” J. Vac. Sci. Technol. A 3 (1995): 1171-1174. A further method of producing single-wall nanotubes is the HiPco process, as disclosed by Nikolaev, P., et al., “Gas-phase catalytic growth of single-walled carbon nanotubes from carbon monoxide,” Chem. Phys. Lett. 313, 91-97 (1999); and by Bronikowski M. J., et al., “Gas-phase production of carbon single-walled nanotubes from carbon monoxide via the HiPco process: A parametric study,” J. Vac. Sci. Technol. 19, 1800-1805 (2001).

The starting materials for the composites of this invention are preferably powder mixtures of the ceramic, the metal, and the single-wall carbon nanotubes. An oxygen getter for the metal can be included as an option, and a convenient getter is the metal on which the ceramic is based. Thus, for composites in which the ceramic material is alumina, a small amount of powdered aluminum metal will serve as an oxygen getter. This is particularly true when the metal is niobium. It is preferred that the mixtures, and the final product as well, be free of multi-wall carbon nanotubes, or if multi-wall carbon nanotubes are present, that the amount of multi-wall nanotubes relative to the amount of single-wall nanotubes be so small that the presence of the multi-wall nanotubes does not obliterate or significantly reduce the beneficial properties attributable to the single-wall nanotubes. It is also preferred that the nanocomposites be free of iron or contain an amount so small that it will not affect the properties of the product.

The relative amounts of ceramic material, metal and single-wall carbon nanotubes can vary, although the mechanical properties and possibly the performance characteristics may vary with the proportions of both the niobium and the single-wall carbon nanotubes. In most cases, particularly when the metal is niobium, best results will be achieved with composites in which the niobium grains constitute from about 1% to about 30%, preferably from about 2% to about 20%, and most preferably from about 2% to about 15%, by volume of the composite, and those in which the single-wall carbon nanotubes constitute from about 1% to about 30%, preferably from about 2% to about 20%, and most preferably from about 2% to about 15%, by volume of the composite. The volumes used in determining the volume percents referred to herein are calculated from the weight percents of the bulk starting materials and the theoretical density of each component.

The ceramic material used as a starting material is preferably in the form of nano-sized particles, i.e., particles whose diameters are less than 100 nm in diameter on the average, and preferably from about 10 nm to about 90 nm on the average. The niobium and single-wall carbon nanotubes can be dispersed through the ceramic powder by conventional means to form a uniformly dispersed powder mixture, although a preferred method is one involving the use of suspensions of all three materials in a liquid suspending medium. The ceramic powder, the niobium, and the carbon nanotubes can thus be suspended in separate volumes of a low molecular weight alcohol (ethanol, for example), followed by combining of the suspensions. Carbon nanotubes are available from commercial suppliers in a paper-like form, and can be dispersed in ethanol and other liquid suspending agents with the assistance of ultrasound.

Once the mixture of ceramic powder, metal powder, and single-wall carbon nanotubes is formed, the mixture is preferably mixed prior to electric field-assisted sintering. Mechanical mixing can be performed by ball-milling in conventional rotary mills that mix the powder mixture with the assistance of tumbling balls. The sizes of the balls, the number of balls used per unit volume of powder, the rotation speed of the mill, the temperature at which the milling is performed, and the length of time that milling is continued can all vary widely. Best results will generally be achieved with a milling time ranging from about 4 hours to about 50 hours. The degree of mixing may also be affected by the “charge ratio,” which is the ratio of the mass of the balls to the mass of the powder. A charge ratio of from about 5 to about 20 will generally provide proper mixing. The milling can be performed on the powders while suspended in the liquid suspending agent referred to above.

Electric field-assisted sintering is performed by passing a pulsewise DC electric current through the powder mixture while pressure is applied. A description of this method and of apparatus in which the method can be applied is presented by Wang, S. W., et al., “Densification of Al₂O₃ powder using spark plasma sintering,” J. Mater. Res. 15(4), 982-987 (2000). While the conditions may vary, best results will generally be obtained with a densification pressure exceeding 10 MPa, preferably from about 10 MPa to about 200 MPa, and most preferably from about 40 MPa to about 100 MPa. The preferred current is a pulsed DC current of from about 250 A/cm² to about 10,000 A/cm², most preferably from about 500 A/cm² to about 1,500 A/cm². The duration of the pulsed current will generally range from about 1 minute to about 30 minutes, and preferably from about 1.5 minutes to about 5 minutes. Preferred temperatures are within the range of from about 800° C. to about 1,500° C., and most preferably from about 900° C. to about 1,400° C. Densification is typically performed by uniaxial compression under vacuum, and preferred vacuum levels for the densification are below 10 Torr, and most preferably below 1 Torr.

The prefix “nano-” as used herein generally refers to dimensions that are less than 100 nm. The ceramic powders used as starting materials in the practice of this invention are preferably in the nano-size range but in many cases undergo grain growth during sintering. The resulting composites may therefore have grain sizes that exceed the nano-size range by several hundred nanometers. In preferred embodiments, the ceramic grains have an average grain size of less than 1,000 nm, and in the most preferred embodiments, the average grain size is less than 600 nm.

The following examples are offered for purposes of illustration and are not intended to limit the scope of the invention.

### EXAMPLES

Materials, Equipment, and Experimental Procedures

The ceramic material was nanocrystalline γ-Al₂O₃ powder with an average particle size of 29 nm, obtained from Nanophase Technologies Corporation (Darien, Ill., USA). Niobium powder with a maximum powder size of 74 microns was obtained from Goodfellow Cambridge Limited (Cambridge, England). Aluminum powder below 325 mesh was obtained from Johnson Matthey Electronics (Ward Hill, Mass., USA). Purified single-wall carbon nanotubes, from which more than 90% of the catalyst particles had been removed, were obtained from Carbon Nanotechnologies Incorporated (Houston, Tex., USA).

The alumina, niobium, and aluminum were first milled together in a volume ratio of 95:5 alumina:metals where the metallic component was 90 weight percent niobium and 10 weight percent aluminum. This procedure thoroughly mixed the alumina and the two metals together while refining the particle size of the metals to the nanocrystalline range. To thoroughly disperse the nanotubes throughout this mixture, the alumina-niobium-aluminum mixture was first ball milled in ethanol with zirconia milling media. The single-wall carbon nanotubes in the “paper” form were then dispersed in a separate volume of ethanol using an ultrasonic bath. The two dispersions were then combined and mixed, and the resulting mixture (still in ethanol) was ball-milled for 24 hours using zirconia milling media. After milling, the combined dispersion was dried to form a dry powder mixture.

The dry powder mixture was then placed on a graphite die of inner diameter 20 mm and cold-pressed at 200 MPa. The cold-pressed powder mixture was then sintered on a Dr. Sinter 1050 Spark Plasma Sintering System (Sumitomo Coal Mining Company, Japan) under vacuum. Electric field-assisted sintering was then performed at an applied pressure of 63 MPa with a pulsed DC current of 5,000 A maximum and a maximum voltage of 10 V, with a pulse duration time of 12 ms separated by intervals of 2 ms. Once the pressure was applied, the samples were heated to 600° C. in 2 minutes and then raised to 1,150° C. for 3 minutes at a heating rate of 550° C./min. The temperature was monitored with an optical pyrometer focused on a depression in the graphite die measuring 2 mm in diameter and 5 mm in depth.

The final densities of the sintered compacts were measured by the Archimedes method using deionized water as the immersion medium. The density of the single-wall carbon nanotubes used as a starting material was 1.8 g/cm³. Microstructure determinations of the sintered compacts were performed with an FEI XL30-SFEG high-resolution scanning electron microscope with a resolution better than 2 nm. Grain sizes were estimated by high-resolution scanning electron microscopy of fractured surfaces. Indentation tests were performed on a Wilson Tukon hardness tester with a diamond Vickers indenter. Bulk specimens were sectioned and mounted in epoxy, then polished through 0.25-micron diamond paste. The indentation parameters for fracture toughness (K_{IC}) were a 2.5 kg load with a dwell time of 15 s. The fracture toughness was calculated by the Anstis equation as disclosed by Anstis, G. R., et al., “A Critical Evaluation of Indentation Techniques for Measuring Fracture Toughness: I, Direct Crack Measurement,” J. Am. Ceram. Soc. 64(9): 533-538 (1981).

A composite containing 5 volume percent niobium and 5 volume percent single-wall carbon nanotubes with alumina as the balance was prepared by the procedure described above. The same procedure was used to prepare a composite containing 10 volume percent niobium with alumina as the balance (lacking single-wall carbon nanotubes) and 10 volume percent single-wall carbon nanotubes with alumina as the balance (lacking niobium). The procedure was also performed on pure alumina. Since pure alumina nanopowders can be consolidated to full density by electric field-assisted sintering at 1,150° C. for three minutes, the alumina and the three composites were all sintered under these conditions.

Results

The relative density, grain size, and fracture toughness were determined on the sintered alumina and the sintered samples of each of the three composites, and the results are listed in Table I, where SWCN denotes single-wall carbon nanotubes.

TABLE I
Compositions, Relative Densities, Grain Size and Fracture
Toughness of Various Alumina Composites vs. Pure Alumina
All Sintered by Electric Field-Assisted Sintering
at 1,150° C. for 3 Minutes

| Composition | Relative | | Fracture |
|---|---|---|---|
| (additive and volume %; | Density | Grain Size | Toughness |
| balance Al₂O₃) | (%) | (nm) | (MPam^{1/2} ) |
| 0% (pure Al₂O₃) | 100 | 349 | 3.3 |
| Nb: 10% | 98 | ˜200 | 7.0 |
| SWCN: 10% | 100 | ˜200 | 9.7 |
| SWCN: 5%; Nb: 5% | 100 | ˜500 | 13.4 |

The composite whose data appears in the last row of Table I is the only composite among those in the Table that represents the present invention. The data show that the fracture toughness of this composite is 38% higher than that of the composite containing single-wall carbon nanotubes in the same total additive concentration and no niobium (third data row in the Table), 91% higher than that of the composite containing niobium in the same total additive concentration and no single-wall carbon nanotubes (second data row in the Table), and 306% higher than that of pure alumina (first row). A synergistic effect of the combination of niobium and single-wall carbon nanotubes is thus demonstrated.

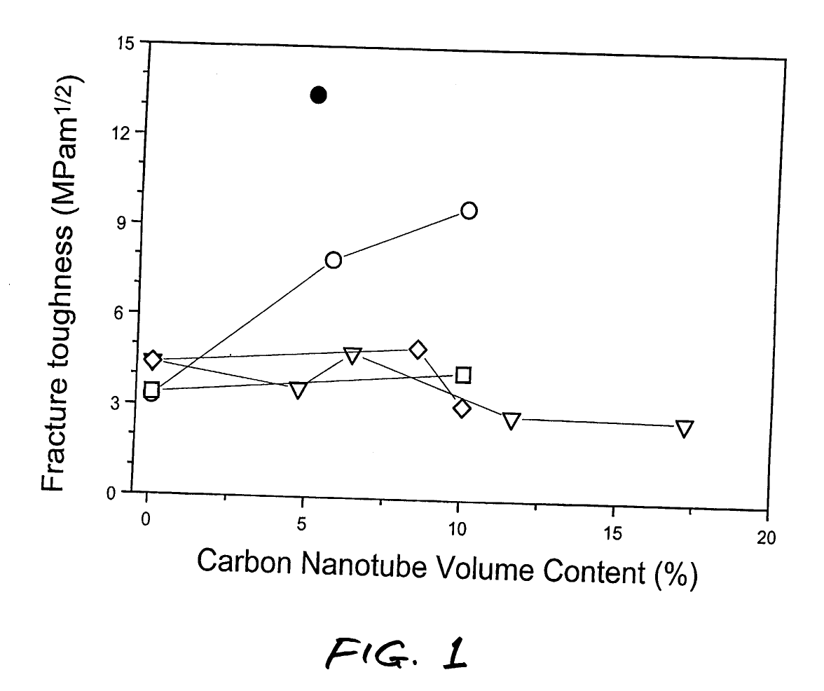

The fracture toughnesses shown in the last two rows of the Table are plotted in FIG. 1 together with fracture toughness data from additional composites, including those of composites selected from the prior art, all plotted as a function of the volume percent of carbon nanotubes in the composite. The symbols used in FIG. 1 are as follows:

filled circle: the 5% niobium, 5% single-wall carbon nanotubes composite of the present invention, sintered as described above

open circles: composites containing various levels of single-wall carbon nanotubes without niobium, sintered as described above

open squares: data generated by Siegel, R. W., et al., “Mechanical Behavior of Polymer and Ceramic Matrix Nanocomposites,” Scripta Mater. 44: 2061-2064 (2001), on composites containing multi-wall carbon nanotubes and in which sintering was performed by hot pressing in the absence of an electric field at 1,300° C. for 60 minutes

open triangles: data generated by Peigney, A., et al., “Carbon Nanotubes in Novel Ceramic Matrix Nanocomposites,” Ceram. Inter. 26: 677-683 (2000), on composites containing single-wall carbon nanotubes and in which sintering was performed by hot pressing in the absence of an electric field, at 1,475° C. for 15 minutes

open diamonds: data generated by Flahaut, E., et al., “Carbon Nanotubes-Metal-Oxide Nanocomposites: Microstructure, Electrical Conductivity, and Mechanical Properties,” Acta Mater. 48: 8303-3812 (2000), on composites containing single-wall carbon nanotubes and in which sintering was performed by hot pressing in the absence of an electric field, at 1,475° C. for 15 minutes

The superiority of the composite of the present invention (the filled circle) over all other composites shown in terms of fracture toughness is apparent from the Figure. Of the last three composites, the best increase in toughness due to the inclusion of carbon nanotubes was reported by Siegel et al., but the increase was only 24%.

The scanning electron microscopy indicated that the composite within the scope of the present invention contained agglomerations containing carbon nanotubes at levels higher than the average of the composite as a whole. This is still considered to be “substantially uniformly dispersed” as the phrase is used herein. Despite these agglomerations, the microscopy also showed ropes of carbon nanotubes that were effectively intertwined with the alumina grains to form a network structure. Still further, the fracture mode was completely intergranular. These features differ considerably from the microstructures shown in the prior art (including the Siegel et al., Peigney et al., and Flahaut et al. references cited above) where cohesion between the carbon nanotubes and the alumina matrix was poor and carbon nanotubes were observed to have separated from the matrix.

The foregoing is offered primarily for purposes of illustration and explanation. Further variations, modifications and substitutions that, even though not disclosed herein, still fall within the scope of the invention may readily occur to those skilled in the art.

What is claimed is:

1. A high-performance ceramic material comprising (i) grains of a metal selected from the group consisting of aluminum, chromium, copper, molybdenum, niobium, nickel, titanium, tungsten, and alloys of such metals, and (ii) single-wall carbon nanotubes, components (i) and (ii) both being substantially uniformly dispersed throughout a matrix of ceramic grains to form a continuous fused mass having a density of at least 99% relative to a volume-averaged theoretical density.

2. A high-performance ceramic material in accordance with claim 1 in which said metal grains constitute from about 1% to about 30% by volume of said continuous fused mass.

3. A high-performance ceramic material in accordance with claim 1 in which said metal is niobium.

4. A high-performance ceramic material in accordance with claim 3 in which said niobium grains constitute from about 1% to about 30% by volume of said continuous fused mass.

5. A high-performance ceramic material in accordance with claim 3 in which said niobium grains constitute from about 2% to about 20% by volume of said continuous fused mass.

6. A high-performance ceramic material in accordance with claim 3 in which said niobium grains constitute from about 2% to about 15% by volume of said continuous fused mass.

7. A high-performance ceramic material in accordance with claim 1 in which said single-wall carbon nanotubes constitute from about 1% to about 30% by volume of said continuous fused mass.

8. A high-performance ceramic material in accordance with claim 1 in which said single-wall carbon nanotubes constitute from about 2% to about 20% by volume of said continuous fused mass.

9. A high-performance ceramic material in accordance with claim 1 in which said single-wall carbon nanotubes constitute from about 2% to about 15% by volume of said continuous fused mass.

10. A high-performance ceramic material in accordance with claim 3 in which said niobium grains constitute from about 2% to about 20% by volume of said continuous fused mass and said single-wall carbon nanotubes constitute from about 2% to about 20% by volume of said continuous fused mass.

11. A high-performance ceramic material in accordance with claim 3 in which said niobium grains constitute from about 2% to about 15% by volume of said continuous fused mass and said single-wall carbon nanotubes constitute from about 2% to about 15% by volume of said continuous fused mass.

12. A high-performance ceramic material in accordance with claim 1 in which said ceramic grains are metal oxide grains.

13. A high-performance ceramic material in accordance with claim 12 in which said metal oxide is a member selected from the group consisting of alumina, magnesium oxide, magnesia spinel, titania, cerium oxide, yttria, and zirconia.

14. A high-performance ceramic material in accordance with claim 12 in which said metal oxide is alumina.

15. A high-performance ceramic material in accordance with claim 1 in which said ceramic grains are alumina and said metal is niobium.

16. A high-performance ceramic material in accordance with claim 15 in which said niobium grains constitute from about 2% to about 15% by volume of said continuous fused mass, and said single-wall carbon nanotubes constitute from about 2% to about 15% by volume of said continuous fused mass.

17. A high-performance ceramic material in accordance with claim 1 in which said ceramic grains have an average grain size of less than 1,000 nm.

18. A high-performance ceramic material in accordance with claim 1 in which said ceramic grains have an average grain size of less than 600 nm.

19. A process for forming a high-performance ceramic material, said process comprising consolidating a mixture of ceramic particles of less than about 100 nm in diameter, metallic particles of less than about 100 microns in diameter, and single-wall carbon nanotubes into a continuous mass by compressing said mixture while passing an electric current through said mixture, said metallic particles being a member selected from the group consisting of aluminum, chromium, copper, molybdenum, niobium, nickel, titanium, tungsten, and alloys of such metals.

20. A process in accordance with claim 19 in which said metallic particles are niobium.

21. A process in accordance with claim 19 in which said ceramic particles are metal oxide particles.

22. A process in accordance with claim 21 in which said metal oxide is a member selected from the group consisting of alumina, magnesium oxide, magnesia spinel, titania, cerium oxide, yttria, and zirconia.

23. A process in accordance with claim 21 in which said metal oxide is alumina.

24. A process in accordance with claim 19 in which said ceramic particles are alumina and said metallic particles are niobium.

25. A process in accordance with claim 20 in which said niobium grains constitute from about 1% to about 30% by volume of said mixture, and said single-wall carbon nanotubes constitute from about 1% to about 30% by volume of said mixture.

26. A process in accordance with claim 20 in which said niobium grains constitute from about 2% to about 20% by volume of said mixture, and said single-wall carbon nanotubes constitute from about 2% to about 20% by volume of said mixture.

27. A process in accordance with claim 19 comprising compressing said mixture at a pressure of from about 10 MPa to about 200 MPa and a temperature of from about 800° C. to about 1,500° C., and said electric current is a pulsed direct current of from about 250 A/cm² to about 10,000 A/cm².

28. A process in accordance with claim 19 comprising compressing said mixture at a pressure of from about 40 MPa to about 100 MPa and a temperature of from about 900° C. to about 1,400° C., and said electric current is a pulsed direct current of from about 500 A/cm² to about 5,000 A/cm².

29. A process for forming a high-performance alumina-based ceramic material, said process comprising:
(a) forming a mixture comprising alumina powder, niobium powder, and single-wall carbon nanotubes in which said niobium powder constitutes from about 2% to about 15% by volume of said mixture and said single-wall carbon nanotubes constitute from about 2% to about 15% by volume of said mixture; and
(b) consolidating mixture into a continuous mass by compressing said mixture at a pressure of from about 40 MPa to about 100 MPa while exposing said mixture to a pulsed direct current of from about 500 A/cm² to about 5,000 A/cm².
